(19) United States
(12) Patent Application Publication
(10) Pub. No.: US 2026/0196552 A1
(43) Pub. Date: Jul. 9, 2026

(54) METHOD FOR CONNECTING AN ARRESTER TO A POLE CAP OF A BATTERY CELL

(71) Applicant: CELLFORCE GROUP GMBH, Tübingen (DE)

(72) Inventors: Jürgen Gräf, Kirchentellinsfurt (DE); Bernd Kaiser, Kirchentellinsfurt (DE); Philipp Steiner, Kirchentellinsfurt (DE); Stefan Doose, Kirchentellinsfurt (DE)

(21) Appl. No.: 19/124,042

(22) PCT Filed: Oct. 26, 2023
(86) PCT No.: PCT/EP2023/080009

§ 371 Date: Apr. 24, 2025

(30) Foreign Application Priority Data
Oct. 26, 2022 (EP) 22203861.4

(51) Int. Cl. H01M 10/04; H01M 10/42; H01M 50/569; H01M 50/572; H01M 50/627; H02H 7/18

(52) U.S. Cl. CPC H01M 10/0481; H01M 10/4235; H01M 50/627; H02H 7/18; H01M 50/569; H01M 50/572

(57) ABSTRACT

A method for connecting an arrester to an inside of a pole cap of an electrochemical cell, wherein a pulling mandrel is pushed through an opening of the pole cap and/or through an opening or recess of the arrester, the pulling mandrel configured to form a mechanical connection between the pulling mandrel and the arrester at least temporarily at a section or being mechanically connected to the arrester, wherein a force directed out of the opening of the pole cap is set on the pulling mandrel and the arrester is pressed against the inner side of the pole cap, wherein the arrester pressed against the inner side of the pole cap is connected to the pole cap, in particular in an electrically conductive manner.

### BACKGROUND

The invention relates to a method for connecting an arrester to an inner side of a pole cap of an electrochemical cell.

In the production of electrochemical storage devices, such as lithium-ion batteries, for example, several alternating layers of anodes, cathodes and separators are usually arranged in the form of cell stacks. The respective anodes and cathodes are each contacted electrically by a respective arrester. When two cell stacks are used, for example, U-shaped arresters are used, in which the two ends face the two cell stacks and the front face faces an inside of a pole cap. The arresters act as an electrical interface between the cell stacks and the pole caps.

Due to the arrangement of pole caps on both sides or opposite each other, the first pole cap can be welded or soldered to the cell stack arrester regularly and without technical challenges. The second pole cap can no longer be connected directly to the arrester. For this purpose, longer connecting lines must be provided between the second arrester and the cell stack, which means that additional housing volume is required for the longer connecting lines resulting from the assembly.

### SUMMARY OF THE INVENTION

According to one aspect of the invention, a method for connecting an arrester to an inner side of a pole cap of an electrochemical cell is provided.

In one step, a pulling mandrel is pushed through an opening, such as a filling opening, of the pole cap and/or through an opening or recess of the arrester. The opening of the arrester can be designed to correspond to the opening of the pole cap. Depending on the design of the pulling mandrel, it is not necessary to take into account an opening of the arrester if the pulling mandrel is mechanically or integrally connected to the arrester.

The pulling mandrel can be expanded at the end of a section of the arrester or be mechanically connected to the arrester to form an at least temporary mechanical connection between the pulling mandrel and the arrester. Depending on the design, the pulling mandrel can be permanently connected to the arrester at the end or can be connected.

In a further step, a force directed out of the filling opening of the pole cap is applied to the pulling mandrel. This presses the arrester against the inside of the pole cap. By pressing or pulling the arrester against the inside of the pole cap, an initial gap between the inside of the pole cap and the arrester can be eliminated, thus optimally preparing for a subsequent joining step. In the joining step, the arrester is then connected to the pole cap, in particular in an electrically conductive manner.

The method can be used to set a so-called zero gap between the pole cap and the arrester in order to implement a process-reliable connection between the pole cap and the arrester. In particular, the method can be used to pull or push the arrester against the pole cap from the outside without exerting any damaging force on the at least one cell stack connected to the arrester.

Furthermore, the method can be used to minimize the need for additional cell volume, since no additional length is required for the connection between the arrester and the cell stack.

According to one embodiment, the pulling mandrel is moved through an opening in the arrester towards an outside. The pulling mandrel is mechanically hooked to the arrester at the end in the area of the opening, in particular in a form-fitting manner. Alternatively, the pulling mandrel is inserted through the openings in the pole cap and the arrester and expanded at the end in the area of the arrester opening, either mechanically or by means of overpressure, in particular pneumatically or hydraulically, or by vacuum, to form a temporary or permanent mechanical connection between the pulling mandrel and the arrester. The end of the pulling mandrel can be enlarged in a variety of ways to lock the arrester in place and thus fix it immovably in at least one direction relative to the pulling mandrel. Depending on the design, the pulling mandrel can hook behind the arrester or form a temporary fixed connection with the arrester in order to be able to move the arrester against the pole cap. Thus, the pulling mandrel can be enlarged or expanded in an opening or recess of the arrester or behind or below the opening in order to be able to move the arrester along at least one direction.

The pulling mandrel can be expanded at the end in such a way that this end section deforms and acts as a rivet, so to speak, to form a mechanical connection between the arrester and the pole cap.

In particular, the pulling mandrel can be designed to pull the arrester and thus press or move it against the inside of the pole cap.

According to a further embodiment, the pulling mandrel has an outer tube section, which has an end spreading section. Preferably, the spreading section is enlarged, at least in some areas, by the impact of excess pressure on the tube section or by the pressing in of a bolt. This allows the pulling mandrel to be expanded at the end in a technically simple manner. In this case, the spreading section can be designed to be elastic, at least in some areas, in order to increase or decrease the dimension of the pulling mandrel transverse to the pulling direction of the arrester. The pulling mandrel can function as a tool with which the spreading section is temporarily expanded. In an alternative or additional design, the pulling mandrel can serve as a connecting means with which the spreading section can be permanently expanded.

The pulling mandrel can be of particularly simple technical design if the spreading section has a spreading element and the spreading element is pulled or pressed into the outer tube section mechanically or by vacuum in order to enlarge the spreading section at least in some areas. Accordingly, the spreading element can be distanced from the outer pipe section by mechanical action or by excess pressure, in order to reduce the size of the spreading section again. Depending on the design, a return spring can be provided which can automatically distance the spreading element from the outer pipe section along the pulling direction of the pulling mandrel in order to reduce the size of the spreading section.

The spreading section can be enlarged by the spreading element along at least one spatial direction transverse to the pulling direction of the pulling mandrel. Depending on the design, the spreading element can be rotationally symmetrical, whereby a uniform enlargement of the spreading section can be implemented.

According to an alternative embodiment, the mechanical connection between the pulling mandrel and the arrester is formed by a rotational movement and/or a translational movement of the pulling mandrel. This allows the pulling mandrel to be pushed through the opening and, by means of a rotational movement or a laterally directed movement or pivoting movement, to hook the arrester in such a way that it can be pressed against the inside of the pole cap. A pulling mandrel of this kind can also be implemented particularly easily in technical terms and integrated into an automated process.

According to a further embodiment, the pulling mandrel has a receiving section and/or a driver. The receiving section is designed to receive part of the arrester laterally. The driver can advantageously project beyond the receiving section, thereby hooking behind the arrester. The receiving section and the driver can be shaped eccentrically with respect to an axis of rotation of the pulling mandrel.

For example, the pulling mandrel can be pushed through the opening until the arrester and the pole cap are at the same height as the receiving section. An optional limiting element of the pulling mandrel can limit or control the required insertion depth of the pulling mandrel through the opening. The tappet acts as a counter surface or contact surface for the arrester.

Depending on the design, the receiving section and the driver of the pulling mandrel can form a screw shape or thread shape. Thus, a pulling mandrel inserted into the opening can be rotated, whereby the effective position of the driver moves in the direction of the inside of the pole cap due to the rotation along the rotation axis of the pulling mandrel and thus presses the arrester and the pole cap together. Alternatively, this can also be realized by a thread of the pulling mandrel outside the electrochemical cell, which changes the axial position or depth position of the pulling mandrel by rotating at least part of the pulling mandrel.

An actuator can implement the rotational and/or translational movement of the pulling mandrel. Optionally, signals or measurement data from sensors and/or end stops can be used to ensure a defined contact pressure of the arrester to the inside of the pole cap. A control unit can implement the coordination between the sensors or end stops or end contacts and the actuators.

Similarly, the control unit can also control the impact of the pulling mandrel with vacuum or overpressure. In this case, further sensors, such as pressure sensors and the like, can be used for targeted control of the pulling mandrel.

In another advantageous design, the pulling mandrel can be pushed through the opening in the arrester before the battery cell or electrochemical cell is installed, so that the end of the tappet can hook behind the opening or another section of the arrester or interact in a form-fitting or frictional manner. The arrester can then be moved towards the pole cap using the pulling mandrel, whereby the pulling mandrel can also be guided through the opening in the pole cap in order to be able to pull the arrester against the pole cap on the inside after the battery cell has been assembled or after the cell housing has been closed. The pulling mandrel can remain in the finished battery cell, at least in sections.

According to a further embodiment, the driver of the pulling mandrel is designed to mechanically engage with the arrester in the area of the opening. The driver can be designed, for example, as a thickened section, as an end T-piece, a head or screw head, a spring, a bulge on the side and the like. The driver can be used to prevent the pulling mandrel from slipping freely through the opening of the arrester.

According to a further embodiment, the pulling mandrel is integrally formed with the arrester or is connected to the arrester. In addition to the pulling mandrel interacting mechanically with the arrester, it can also be glued, welded, soldered, crimped or clamped to the arrester to form a connection between the pulling mandrel and the arrester that allows a force to be applied to the pulling mandrel to pull the arrester against the pole cap.

A pulling mandrel that is firmly connected to the arrester, for example by means of welding or soldering, can be considered, for example, to be a pulling mandrel that is integrally designed with the arrester. In the course of production, an integral assembly consisting of the pulling mandrel and the arrester can also be formed, for example by injection molding.

The arrester is advantageously moved to the inside of the pole cap in such a way that the pulling mandrel is guided through the opening of the pole cap to the outside.

This allows the pulling mandrel to remain in the battery cell in sections. After connecting the pole cap to the arrester, the section of the pulling mandrel protruding from the opening of the pole cap can be removed by milling, cutting, tearing, etc. Depending on the design, a connection between the arrester and the pole cap can be established via a direct connection between the arrester and the pole cap and/or via an indirect electrically conductive connection from the pole cap via the section of the pulling mandrel remaining in the battery cell to the arrester.

According to a further embodiment, the arrester is connected to the pole cap in a form-fitting or materially bonding or frictionally locking manner by the spreading section of the pulling mandrel. For example, the arrester can be connected to the pole cap by laser welding, tab welding, so-called e-filling, riveting, canting, pressing and the like. This allows the electrically conductive connection between the pole cap and the arrester to be realized in a variety of ways. In this case, the pulling mandrel can alternatively or additionally act as a rivet or blind rivet. The driver can be coupled to the arrester and the spreading section can be coupled to the pole cap, whereby the arrester can be connected to the pole cap in a technically particularly simple manner. In this case, the spreading section can advantageously be deformed, in particular fanned out or widened, after the tensile force has been applied to the protruding section of the pulling mandrel.

A pulling mandrel that is integrally formed with the arrester can be used in the same way. In this case, the spreading section can be positioned at a distance from the arrester, allowing it to be deformed inside the opening of the pole cap or outside the opening of the pole cap.

Furthermore, a hole can be welded through the pole cap and/or in the area of the opening of the pole cap, for example by laser welding.

A section of the pulling mandrel that protrudes from the battery cell can be removed particularly easily if the pulling mandrel has a predetermined breaking point. It is advantageous if, after the spreading of the spreading section, a pulling force and/or a torque is applied to the pulling mandrel in such a way that at least a section of the pulling mandrel is separated along the predetermined breaking point. This measure makes it possible to remove a protruding pulling mandrel, which remains permanently in the battery cell in sections, without additional tools or with a minimal amount of tooling.

Any remaining tear-off edge or stump of the pulling mandrel can be removed by welding, milling, grinding or similar.

The arrester can be tilted or pressed, for example, by notching or deforming the pole cap in at least one lateral section. This is achieved in particular by a plastic deformation, at least in some areas, of the pole cap and results in a mechanical connection between the pole cap and the arrester. For this purpose, the pole cap can engage around the arrester on the inside in order to be able to form an electrical contact also on side walls of the pole cap and the arrester.

According to a further embodiment, the pole cap has at least one connecting opening. Preferably, a line weld or a plug weld or a soldered connection is introduced through the at least one connecting opening in order to form a material bond between the arrester and the pole cap. This measure ensures that a material bond is formed between the pole cap and the arrester. In addition, the formation of such a connection can be reliably checked as part of a quality management process.

The process can be used in the automated production of cells or battery cells if, after connecting the arrester to the pole cap, the pulling mandrel is removed from the filling opening and the filling opening is used to fill with electrolyte.

Alternatively, the tube section of the pulling mandrel that protrudes from the pole cap opens into an opening designed as a filling opening, which is used to fill the electrolyte. This measure enables the pulling mandrel to be used as a filling nozzle before the protruding section of the pulling mandrel is cut off. This measure also allows the pulling mandrel to be used for a variety of possible tasks in battery cell production.

In particular, depending on the design, several pulling mandrels used in parallel can simultaneously lock several arresters and press them against several pole caps on the inside. The respective pole caps and arresters can then be coupled in an electrically conductive manner at the same time by means of several parallel connections. This results in an optimal scalability of the process for a fast series production of battery cells. This measure can be implemented equally well with a pulling mandrel that remains permanently in the battery cell in sections or with a pulling mandrel that is inserted temporarily.

After the spreading sections of the pulling mandrels have been reduced in size again, the pulling mandrels that have been inserted temporarily can be pulled out of the openings or filling openings to enable the cells to be filled afterwards. This means that the filling opening can be used for several tasks, namely tightening the arrester and filling the cell. The temporarily inserted pulling mandrels can essentially use the spreading section to lock the arrester. By contrast, the pulling mandrels permanently remaining in the battery cell in sections can use the spreading section to permanently lock the pole cap, thus realizing the function of a rivet.

In a further embodiment, the filling opening is sealed in a fluid-tight manner after filling with the electrolyte. This step of the process can be realized technically simply, for example, by inserting a plug or blind plug or by closing the filling opening in a materially cohesive manner.

The cells can be filled particularly quickly if a vacuum or a vacuum is created in advance in the internal volume of the cell.

According to a further embodiment, the pulling mandrel is expanded and/or hooked at the end in the area of a recess in the arrester, which is designed as a blind hole or as an extruded profile, in order to couple it mechanically. This measure allows the use of cost-efficient extruded profiles that are tailored to the dimensions of the pole caps. This means that the arresters can be manufactured in a particularly simple way. Such extruded profiles can be used for both temporary and permanent pulling mandrels. In the case of temporarily inserted pulling mandrels, spreading sections can engage in a section of the profile in order to be able to move the arrester from the outside. In the case of a permanently installed pulling mandrel, which remains in the battery cell in sections, a permanently formable spreading section or a driver can interact with the section of the profile in a form-fitting or friction-fitting manner in order to be able to move the arrester from the outside.

The use of blind holes and of depressions or grooves in extruded profiles can enable the arrester to be attached to the pole cap and the cell to be filled with an electrolyte solution at the same time.

The arrester can be electrically connected to the pole cap in a technically particularly simple manner if the arrester has at least one lateral connecting section which essentially corresponds to an inner contour of the pole cap on the inside. In this case, the arrester is connected to the pole cap by plastically deforming the pole cap in the area of the connecting section. For example, notching or pressing in the pole cap on the outside in the area of the connecting section can create an electrically conductive connection between the pole cap and the arrester.

The arrester can be connected to the pole cap in an electrically conductive manner with particular technical ease if the arrester is connected to the pole cap, at least in some areas, by means of a through-weld through the pole cap. For example, an arrester that is attracted or pressed to the inside of the pole cap by the pulling mandrel can be connected in a materially integral manner along the through-weld that has been made by means of laser welding.

In an alternative or additional design, the arrester is connected to the pole cap in an electrically conductive manner by welding a joint between the spreading section and the opening of the pole cap, in particular in the area of a predetermined breaking point. This allows the arrester to be indirectly connected to the pole cap via a section of the pulling mandrel, for example between the tappet and the spreading section. In addition to the forces acting between the arrester, the driver, the spreading section and the pole cap, an optimal or additional weld or soldered connection can improve the electrical contact resistance between the components.

Alternatively, or additionally, a welded connection can be formed between the arrester and the pole cap in the area of the edges of the openings or filling openings. This can be done with or without a permanently used pulling mandrel or section of the pulling mandrel.

The method can advantageously be implemented with one or more pulling mandrels. In this case, a pulling mandrel that is only inserted temporarily from the outside or a pulling mandrel that only remains permanently can be used, or a combination of pulling mandrels that are inserted temporarily and permanently.

### BRIEF DESCRIPTION OF THE DRAWINGS

Several examples of the invention are explained in more detail in the drawings below which show:

FIG. 1 is a schematic cross-section of a battery cell with two cell stacks connected in parallel and pole caps arranged opposite each other;

FIG. 2 is a detailed view B from FIG. 1 to illustrate a method according to a first embodiment of the invention;

FIG. 3 is a detailed view to illustrate an arrester connected to a pole cap by means of a through-weld;

FIG. 4 is a detailed view to illustrate an arrester connected to a pole cap by means of a plug weld;

FIG. 5 is a top view of a pole cap of the battery cell shown in FIG. 1;

FIGS. 6a and 6b are detailed views of a battery cell with an arrester designed as an extruded profile;

FIGS. 7a and 7b are detailed views of a battery cell to illustrate a connection of an arrester to a pole cap by plastic deformation;

FIGS. 8a-8c are schematic detailed views to illustrate a method according to a second embodiment of the invention and

FIGS. 9a and 9b are schematic detail views for illustrating a method according to a third embodiment of the invention.

### DETAILED DESCRIPTION OF THE PREFERRED EMBODIMENTS

In the figures, identical reference numbers characterize the same elements or constructive components. The sizes and relative positions of the elements in the figures are not necessarily drawn to scale, and some of these elements are enlarged and positioned for the sake of clarity. Furthermore, the particular shapes of the elements drawn are not intended to convey any information about the actual shape of the individual elements, but were merely selected to make them easier to recognize in the illustrations.

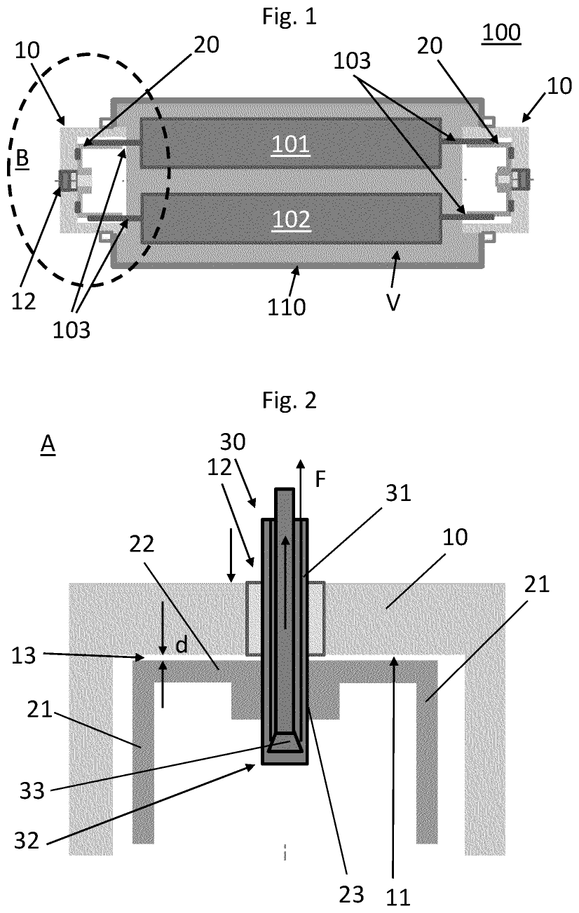

FIG. 1 shows a schematic cross-section of an electrochemical cell or battery cell 100 with two cell stacks 101, 102 connected in parallel and pole caps 10 arranged opposite each other. The battery cell 100 has a double-sided or opposite arrangement of pole caps 10. Two cell stacks 101, 102 are arranged in the cell housing 110, which are each connected on the front side via connecting lines 103 to an arrester 20 in an electrically conductive manner. The cell housing 110 can, for example, have a rectangular or square cross-section and can be closed at the front end directly or indirectly by the pole caps 10 in order to receive an electrolyte solution.

At least one filling opening 12 is provided to introduce the electrolyte solution into a housing volume V of the battery cell 100, which extends through at least one pole cap 10.

In the illustrated example, the arresters 20 are designed as U-shaped arresters and have two legs 21, which each make electrical contact with a cell stack 101, 102. The legs 21 of the arresters 20 are connected to one another by a crosspiece 22. The crosspiece 22 is connected in an electrically conductive manner to an inner side 11 of the pole cap 10, so that the cell stacks 101, 102 are designed in an electrically conductive manner with the pole caps 10. These details are illustrated, for example, in FIG. 2.

A first arrester 20 can be electrically connected to a first pole cap 10 in a technically simple manner. However, subsequently connecting a second arrester 20 to a second pole cap 10 requires additional measures, which are described in more detail below. To avoid internal damage to the battery cell 100, no direct force may be applied to the cell stacks 101, 102.

For a reliable electrical connection between the arrester 20 and the pole cap 10, an initial gap 13 with a distance d between the inside 11 of the pole cap 10 and the arrester 20 must be eliminated and a so-called zero gap must be formed. FIG. 2 shows a detailed view B of FIG. 1 to illustrate a method according to an embodiment of the invention, which also describes a way of forming the zero gap. For the sake of clarity, the internal components, such as the cell stacks 101, 102 and the connecting lines 103, are not shown in FIG. 2 and the following figures.

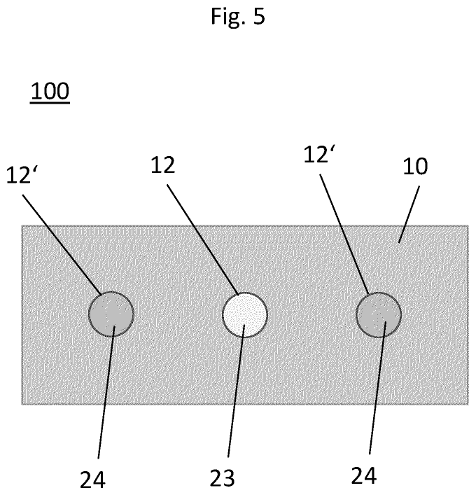

In one step of the method according to the invention, a pulling mandrel 30 that can be expanded at the end is pushed from the outside or from an outer side A through an opening 12 of the pole cap 10. In the illustrated embodiment, the opening 12 is designed as a filling opening for introducing an electrolyte solution into the housing volume V. The pulling mandrel 30 is also pushed through or into an opening 23 or recess 24 of the arrester 20, which corresponds to the opening 12. An arrester 20 with such a recess 24 is illustrated, for example, in FIG. 5. In the illustrated example, the pulling mandrel 30 remains temporarily in or on the components 10, 20 in order to be able to adjust the zero gap.

The pulling mandrel 30 is then expanded at the end in the area of opening 23 or recess 24 of the arrester 20 to form a temporary mechanical connection between the pulling mandrel 30 and the arrester 20.

In a further step, a force F directed out of the opening 12 of the pole cap 10 is set on the pulling mandrel 30. This presses the arrester 20 against the inside 11 of the pole cap 10.

Pressing the arrester 20 against the inside 11 of the pole cap 10 eliminates the initial gap 13 between the inside 11 of the pole cap 10 and the arrester 20, thus optimally preparing for a subsequent joining step. Subsequently, in the joining step, the arrester 20 is connected to the pole cap 10 in an electrically conductive and preferably also mechanical manner.

The pulling mandrel 30 has an outer tubular section 31 and an end spreading section 32. In the illustrated embodiment, a spreading element 33 is arranged in the spreading section 32. The spreading element 33 is designed to be conical, tapering in the direction of the force F, and can be drawn into the tube section by a mechanical operation or by a vacuum in such a way that the end-side spreading section acquires an increase in cross-section. The arrow in pipe section 31 schematically illustrates the movement of the spreading element 33. This cross-sectional enlargement results in the spreading section 32 being locked with the opening 23 of the arrester 20.

The locking mechanism can be designed as a restriction of the mobility of the arrester 20 by means of an at least partial form-fitting of the spreading section 32. In FIG. 2, for example, the spreading section 32 hooks behind below the opening 23 of the arrester 20 in order to be able to pull the arrester 20 against the inside 11 of the pole cap 10.

As a result of the impact of force F on the arrester 20, no force is exerted on the cell stacks 101, 102 at the same time. Preferably, a decoupling between the cell stacks 101, 102 and the arrester 20 is achieved by the connecting lines 103. For this purpose, the connecting lines 103 can, for example, be designed to be slightly longer than a distance between the legs 21 of the arrester 20 and the end faces of the cell stacks 101, 102.

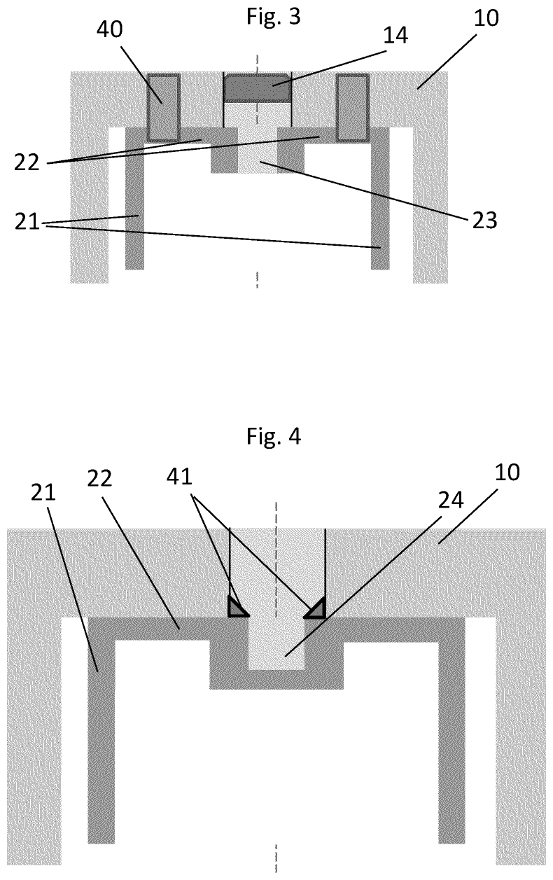

FIG. 3 shows a detailed view to illustrate an arrester 20 connected to a pole cap 10 by means of a through weld 40. An alternative or additional option for a material-locking connection between the pole cap 10 and the arrester 20 is shown in FIG. 4, which shows a detailed view of an arrester 20 connected to a pole cap 10 by means of a plug weld 41.

One or more welds 40 are produced, for example, by laser welding. After setting the zero gap between the arrester 20 and the pole cap, a non-represented welding device can be placed on the outside of the pole cap 10 and operated at least in some areas.

A weld 40 can, for example, enclose a point, a line and/or a closed area on the pole cap 10. Due to the relatively low material thickness of the pole cap 10, the crossbar 22 of the arrester 20, which is located behind the pole cap 10, is also melted and thus firmly connected to the pole cap 10.

A hole welding 41 can be made, for example, at the edge of the filling opening 12 or in the area of a connecting opening 12′ (see FIG. 5). In this process, an edge area of the filling opening 12 is melted by a welding process in order to connect the pole cap 10 to the arrester 20. This still leaves a fluid channel for filling the battery cell 100 with the electrolyte solution.

If, as indicated in FIG. 5, further openings or connecting openings 12′ are used, these can be used to set a weld point, for example by means of laser welding, and thus completely close the connecting opening 12′. A corresponding connection opening 12′ can preferably be designed as a blind hole. In this case, a recess or depression 24 of the arrester 20 or the crossbar 22 of the arrester 20 is positioned behind the opening 12′ in the pole cap 10.

Furthermore, FIG. 4 shows a detailed view of an arrester 20 connected to a pole cap 10 by means of a punched weld, in which the arrester 20 can be pulled through the pulling mandrel 30 onto the inner side 11 of the pole cap 10 not at a corresponding opening 23 but at a depression or recess 24. A material-locking connection between the recess 24 and the pole cap 10 is designed to be particularly fluid-tight and does not require any additional closures 14 (see FIG. 3). However, the filling opening 12, 23 requires a closure 14 after the battery cell 100 has been filled.

The closure 14 can be a reversible or an irreversible closure, which allows the housing volume V to be opened again or permanently seals the battery cell 100. For example, the closure 14 can be designed as a plug, a screw cap, a melt seal or the like.

In an alternative or additional design, the recess 24 can have an internal thread so that, as an alternative to a welded connection, a screw connection can be formed between the pole cap 10 and the arrester 20 by means of a screw that is not shown.

The recess 24 or indentation can be made in the crosspiece 22 of the arrester 20 by removing material or by a forming process, such as punching. At the same time, the legs 21 of the arrester 20 can also be formed, for example with a punching or forming step.

FIG. 5 shows a top view of a pole cap 10 of the battery cell 100 shown in FIG. 1. The pole cap 10 has a centrally arranged filling opening 12 and two openings 12′, which are arranged above recesses 24 of the arrester 20. The filling opening 12 is arranged above a corresponding opening 23 of the arrester 20 and forms a fluid channel to the housing volume V of the battery cell 100.

In the illustrated embodiment, for example, the openings 12′ designed as blind holes can be used to form a connection between the pole cap 10 and the arrester 20. In order for the introduced weld seam or weld point to have the smallest possible projection, the pole cap 10 can have an unillustrated recess or phasing in the area of the openings 12′.

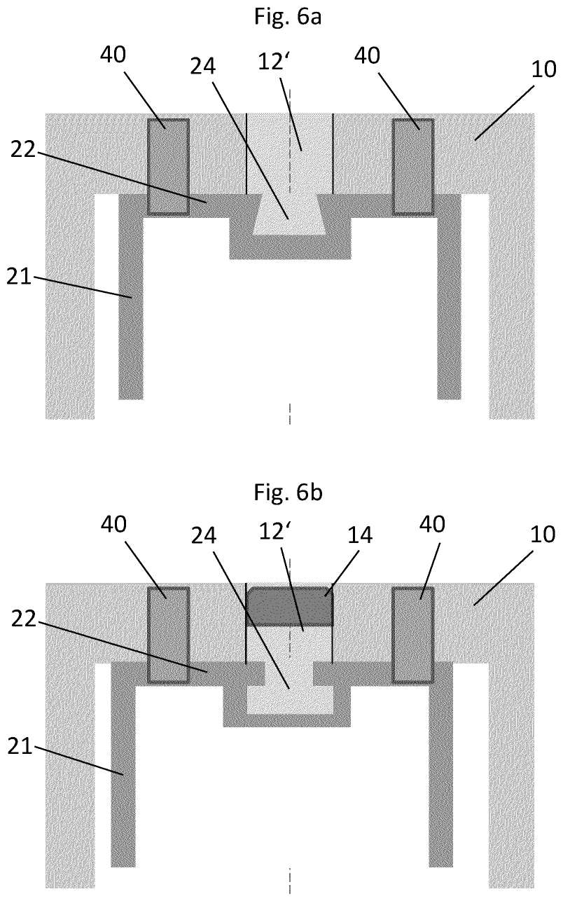

FIGS. 6a and 6b show detailed views of a battery cell 100 with an arrester 20 designed as an extruded profile. FIG. 6a shows an arrester 20 consisting of an extruded profile with a V-shaped recess or depression 24. In comparison, in FIG. 6b the depression 24 is T-shaped.

The corresponding recesses 24 extend over the entire length of the arrester 20 along one spatial direction. The crosspiece 22 of the arrester 20 is interrupted by the recess 24 or has the recess 24. Such arresters 20 can be manufactured in a technically particularly simple manner, whereby prefabricated extruded profiles are sawn to a predefined length.

Due to the recess 24 extending over the entire length or width of the arrester 20, a blind hole is formed with the opening 12′ of the pole cap 10, but an additional closure 14 is advantageous to prevent leakage of the electrolyte solution. This design is illustrated schematically in FIG. 6b.

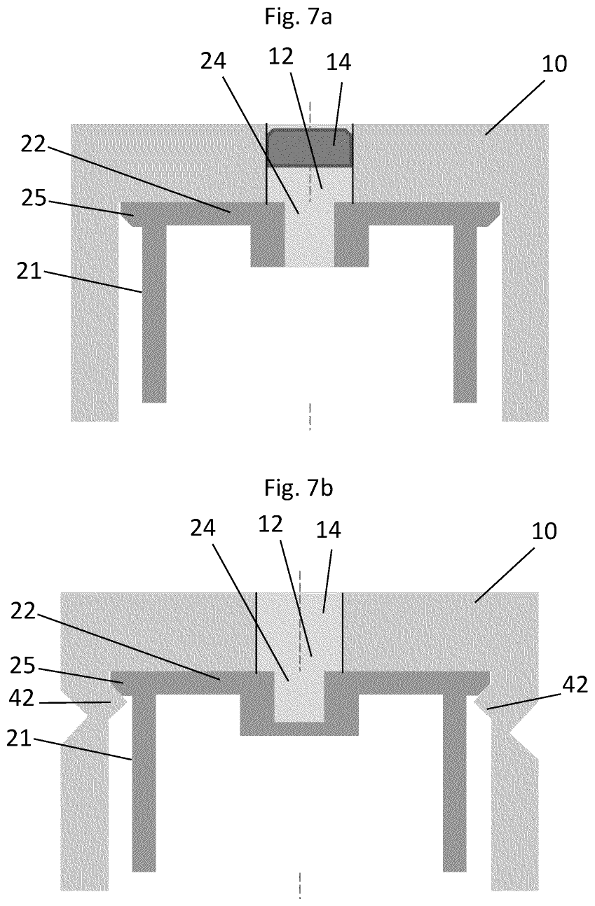

FIG. 7a and FIG. 7b show detailed views of a battery cell 100 to illustrate a connection of an arrester 20 to a pole cap 10 by plastic deformation 42. For such an electrically conductive connection between the pole cap 10 and the arrester 20, the arrester 20 has at least one lateral connection section 25. In the illustrated embodiment, a connecting section 25 is arranged on two opposite sides or edges of the arrester 20 in a transition region between a respective leg 21 and the crosspiece 22, which connecting section 25 is formed, for example, as a lateral extension of the crosspiece 22.

The lateral connecting sections 25 essentially correspond to a lateral inner contour of the pole cap 10. FIG. 7b illustrates the plastic deformation of the pole cap 10 in the area of the connecting sections 25. This is done, for example, by notching or pressing in the pole cap 10 on the outside in the area of the connecting sections 25 or below the connecting sections 25, thereby creating an electrically conductive connection between the pole cap 10 and the arrester 20.

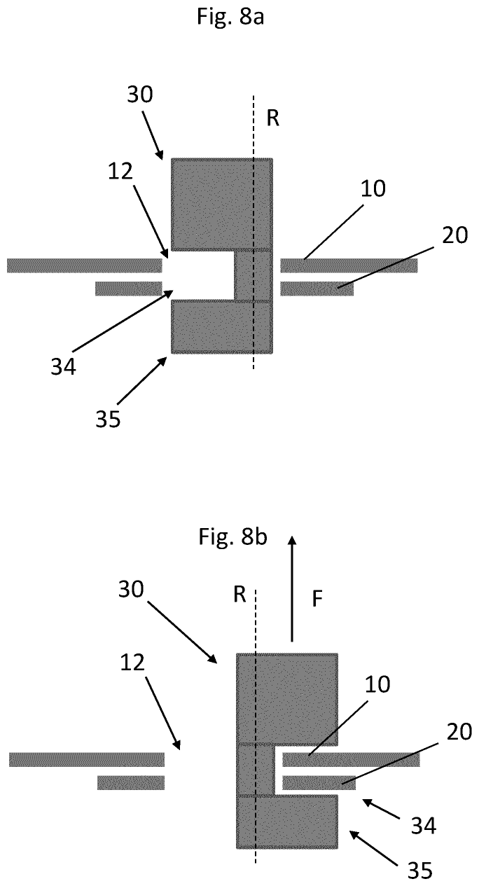

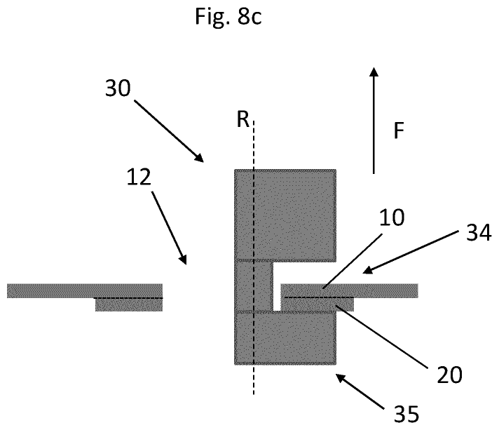

FIG. 8a, FIG. 8b and FIG. 8c show schematic detailed views to illustrate a method according to a second embodiment of the invention. In contrast to the pulling mandrel 30 shown in FIG. 2, this embodiment illustrates a pulling mandrel 30 which can form a mechanical connection to the arrester 20 by means of a rotational movement and/or a translational movement of the pulling mandrel 30, in order to be able to pull the latter against the pole cap 10 on the inside.

For the sake of simplicity, the pulling mandrel 30 shown is designed to rotate around an axis of rotation R and has an eccentrically shaped receiving section 34 and a driver 35. The receiving section 34 is designed as a recess and the tappet 35 delimits the receiving section 34 at the end. The tappet 35 acts as a contact surface for the arrester 20. After inserting the pulling mandrel 30 into the opening 12, the receiving section 34 is at the same axial height or depth with the arrester 20 and the pole cap 10. This step is shown in FIG. 8a.

In a subsequent step, which is illustrated in FIG. 8b, the pulling mandrel 30 is turned along the axis of rotation R, for example by 90° to 180°, allowing the tappet 35 to hook behind the arrester 20. The arrester 20 and the pole cap 10 thus project into the receiving section.

Subsequent pulling of the pulling mandrel 30 out of the opening 12 with the pulling force F allows the zero gap to be set and the arrester 20 to be pressed against the pole cap 10, thus ensuring, for example, reliable welding of the two components 10, 20. This step is shown in FIG. 8c. After welding the arrester 20 to the pole cap 10, the pulling mandrel 30 can be turned further along the axis of rotation R or turned back to align the driver 35 with the opening 12 and to allow removal of the pulling mandrel 30 from the electrochemical cell 100.

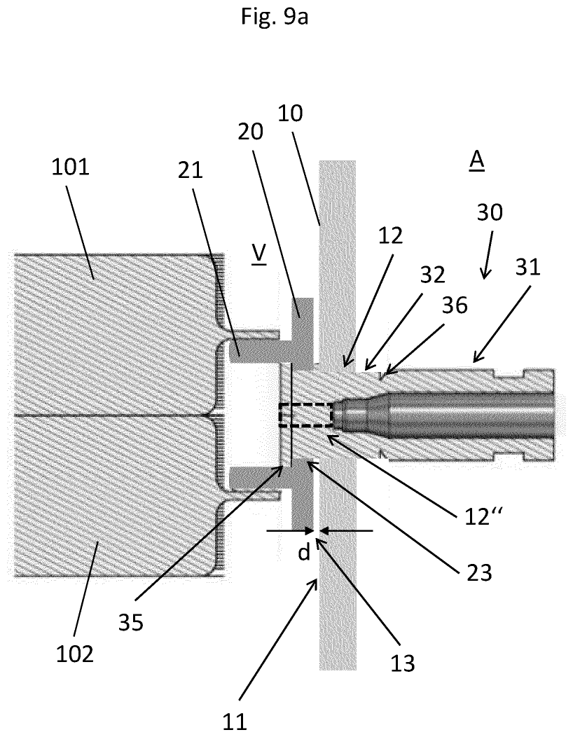

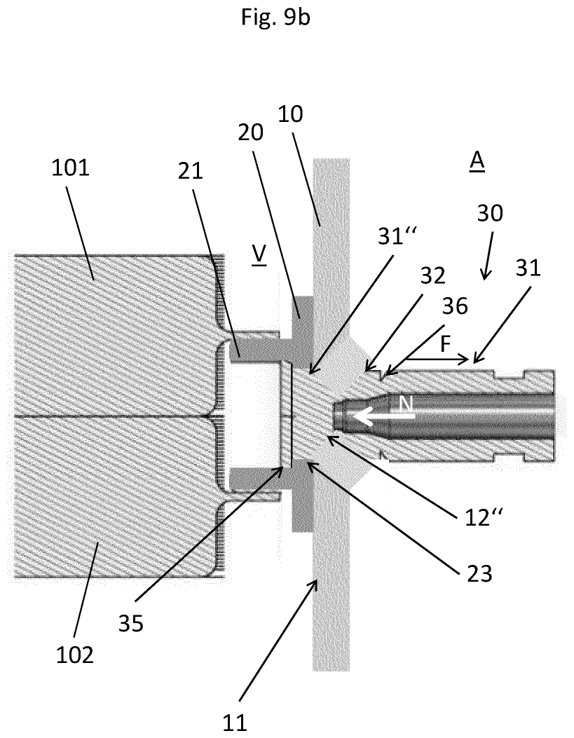

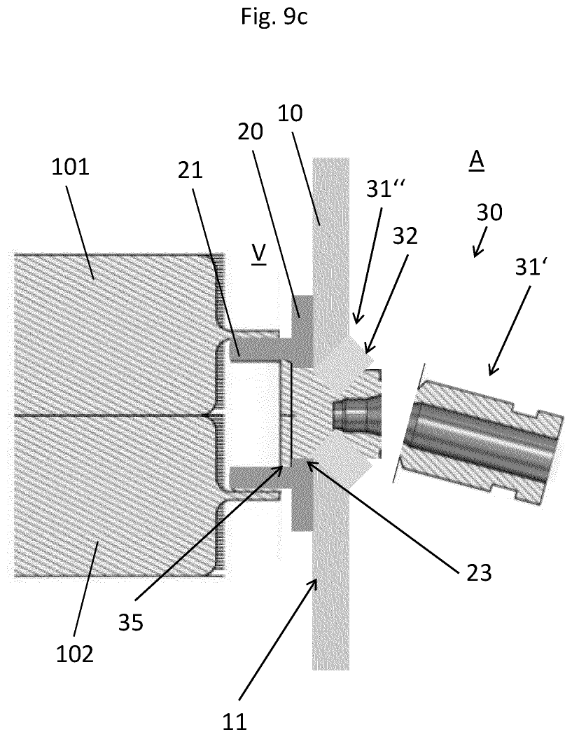

FIG. 9a, FIG. 9b and FIG. 9c show schematic detailed views to illustrate a method according to a third embodiment of the invention. In contrast to the already shown examples, in the first step, which is illustrated by FIG. 9a, a pulling mandrel 30 is used, which can remain permanently in the battery cell 100 in sections.

The pulling mandrel 30 has a driver 35 formed at the end. The driver 35 acts as a contact surface for the arrester 20 in the area of the opening 23 and remains permanently in the battery cell 100. Depending on its design, the driver 35 can lock the arrester 20 in one direction or in several directions or limit its movement. In the illustrated example, for example, there is a limitation against one direction of the force F, which acts on the pulling mandrel 30 to eliminate the initial gap 13.

The pulling mandrel 30 can, for example, be arranged on the arrester 20 before the pole cap 10 is mounted. The pole cap 10 is positioned on the arrester 20 in such a way that the pulling mandrel 30 inserted in advance is guided through the opening 12.

In an alternative embodiment, the pulling mandrel 30 can be a component of the arrester 20. In this case, an integral unit can be produced from a pulling mandrel 30 and the arrester 20 or can be formed by a material-locking or form-locking connection of a pulling mandrel 30 to an arrester 20. Thus, the pulling mandrel 30 can be welded, canted, glued, crimped or the like to the arrester 20. This ensures particularly optimal electrical conductivity between the pulling mandrel 30 and the arrester 20.

The pulling mandrel 30 also has an outer tube section 31 and a spreading section 32. In the illustrated example, the spreading section 32 is arranged downstream of the tappet 35 in the direction of the outside A.

The spreading section 32 is positioned at a distance from the arrester 20, whereby the latter can be deformed within the opening 12 of the pole cap 10 or outside the opening 12 of the pole cap 10. In addition, the pulling mandrel 30 has a predetermined breaking point 36, which is located downstream of the spreading section 32.

FIG. 9b illustrates a step in the process in which the force F is set on the pulling mandrel 30. This eliminates the initial gap 13 between the arrester 20 and the inside 11 of the pole cap 10. This tension between the components 10, 20, 30 is maintained and the spreading section 32 is spread. This can be achieved, for example, by inserting a non-shown spreading element in the form of a bolt through the tube section 31, which results in an increase in cross-section due to plastic deformation of the spreading section 32. The force N required for plastic deformation is shown schematically and is realized against the tensile force F on the pulling mandrel 30. Due to the deformation of the spreading section 32, the pulling mandrel 30 fulfills the function of a rivet and connects the arrester 20 to the pole cap 10.

Depending on the design, the tube section 31 can open into an integrated 12″ opening in the pulling mandrel 30 in the area of the spreading section 32, which can be used as a filling opening for electrolyte.

Subsequently, a protruding section 31′ of the pulling mandrel 30 can be removed along the predetermined breaking point 36. Overuse of the predetermined breaking point 36 can be caused by tilting and/or twisting the section 31′ of the pulling mandrel 30 relative to the pole cap 10 or the plastically deformed spreading section 32. This step is illustrated in FIG. 9c. Thus, a permanent mechanical connection is formed between the pulling mandrel 30, the arrester 20 and the pole cap 10.

31″ section of the pulling mandrel 30 that remains permanently in the battery cell 100 can be machined in the area of the plastically deformed spreading section 32 to prepare an outer surface of the pole cap 10 according to the requirements.

The remaining section 31″ of the pulling mandrel 30 forms not only the mechanical connection but also an electrically conductive connection between the arrester 20 and the pole cap 10. Optionally, the deformed spreading section 32 of the remaining section 31″ and the transition area to the pole cap 10 can be machined by milling, drilling, grinding, welding and the like. For example, the section 31″ can be planned by sliding friction, such as the flowdrill process.

1.-15.

16. A method for connecting an arrester to an inner side of a pole cap of an electrochemical cell, wherein a pulling mandrel is pushed through an opening of the pole cap and/or through an opening of the arrester, wherein the pulling mandrel is arranged to form a mechanical connection between the pulling mandrel and the arrester at least temporarily at a section or is mechanically connected to the arrester, wherein a force directed out of the opening of the pole cap is set on the pulling mandrel and the arrester is pressed against the inside of the pole cap, and wherein the arrester pressed against the inside of the pole cap is connected to the pole cap, in particular in an electrically conductive manner.

17. The method according to claim 16, wherein the pulling mandrel is moved through an opening of the arrester in the direction of an outer side, wherein the pulling mandrel is positively mechanically interlocked with the arrester at the end in the region of the opening, or wherein the pulling mandrel is spread at the end in the region of the opening of the arrester mechanically or by pneumatic, hydraulic or vacuum overpressure to form a temporary or permanent mechanical connection between the pulling mandrel and the arrester.

18. The method according to claim 17, wherein the pulling mandrel has an outer tube section which has a spreading section at the end, wherein the spreading section is enlarged at least in some areas by impacting the tube section with excess pressure or by pressing in a bolt or an expanding element.

19. The method according to claim 18, wherein the spreading section comprises an expanding element, wherein the expanding element is pulled or pressed mechanically or by vacuum into the outer tube section to enlarge the spreading section at least in some areas.

20. The method according to claim 16, wherein the mechanical connection between the pulling mandrel and the arrester is formed by a rotational movement and/or a translational movement of the pulling mandrel.

21. The method according to claim 20, wherein the pulling mandrel has a receiving portion and/or a driver.

22. The method according to claim 21, wherein the driver of the pulling mandrel is configured to mechanically hook with the arrester in the region of the opening.

23. The method according to claim 22, wherein the pulling mandrel is integral with the arrester or is connected to the arrester, wherein the arrester is moved to the inside of the pole cap such that the pulling mandrel is passed through the opening of the pole cap to the outside.

24. The method according to claim 23, wherein the arrester is connected to the pole cap in a form-fitting or material-fitting or friction-fitting manner by the spread spreading section of the pulling mandrel.

25. The method according to claim 24, wherein the pulling mandrel has a predetermined breaking point, wherein after the spreading of the spreading section the pulling mandrel is impacted with a tensile force and/or a torque in such a way that at least a portion of the pulling mandrel is severed along the predetermined breaking point.

26. The method according to claim 25, wherein the pole cap has at least one connecting opening, wherein a line weld or a hole weld or a soldered connection is introduced through the at least one connecting opening in order to form a material-fitting connection between the arrester and the pole cap.

27. The method according to claim 26, wherein after connecting the arrester to the pole cap, the pulling mandrel is removed from the opening configured as a filling opening and the opening is used for filling an electrolyte, or wherein the tube section of the pulling mandrel opens into an opening configured as a filling opening, which is used for filling the electrolyte.

28. The method according to claim 16, wherein the pulling mandrel is spread and/or hooked at the end in the region of a recess of the arrester configured as a blind hole or as an extruded profile in order to couple it mechanically.

29. The method according to claim 16, wherein the arrester has at least one lateral connecting section which corresponds to an inner contour of the pole cap in the region of the inner side, wherein the arrester is connected to the pole cap by plastic deformation of the pole cap in the region of the connecting section.

30. The method according to claim 16, wherein the arrester is connected to the pole cap at least in some areas by welding through the pole cap and/or by welding a joint between the spreading section and the opening of the pole cap in the area of a predetermined breaking point.

31. The method according to claim 16, wherein the pulling mandrel is integral with the arrester or is connected to the arrester, wherein the arrester is moved to the inside of the pole cap such that the pulling mandrel is passed through the opening of the pole cap to the outside.

32. The method according to claim 16, wherein the arrester is connected to the pole cap in a form-fitting or material-fitting or friction-fitting manner by the spread spreading section of the pulling mandrel.

33. The method according to claim 16, wherein the pulling mandrel has a predetermined breaking point, wherein after the spreading of the spreading section the pulling mandrel is impacted with a tensile force and/or a torque in such a way that at least a portion of the pulling mandrel is severed along the predetermined breaking point.

34. The method according to claim 16, wherein the pole cap has at least one connecting opening, wherein a line weld or a hole weld or a soldered connection is introduced through the at least one connecting opening in order to form a material-fitting connection between the arrester and the pole cap.

35. The method according to claim 16, wherein after connecting the arrester to the pole cap, the pulling mandrel is removed from the opening configured as a filling opening and the opening is used for filling an electrolyte, or wherein the tube section of the pulling mandrel opens into an opening configured as a filling opening, which is used for filling the electrolyte.
